(19) United States
(12) Patent Application Publication
(10) Pub. No.: US 2019/0079771 A1
(43) Pub. Date: Mar. 14, 2019

(54) LOOKAHEAD OUT-OF-ORDER INSTRUCTION FETCH APPARATUS FOR MICROPROCESSORS

(71) Applicant: Yong-Kyu Jung, Fairview, PA (US)

(72) Inventor: YONG-KYU JUNG, FAIRVIEW, PA (US)

(21) Appl. No.: 16/125,756

(22) Filed: Sep. 9, 2018

Related U.S. Application Data
(60) Provisional application No. 62/557,169, filed on Sep. 12, 2017.

(51) Int. Cl. G06F 9/38; G06F 12/0875

(52) U.S. Cl. CPC G06F 9/3806; G06F 2212/452; G06F 9/3855; G06F 12/0875

(57) ABSTRACT

A lookahead out-of-order instruction fetch (i-fetch) mechanism using separated control flow is invented for a microprocessor system. An application or compiled code is compiled to separate control-flow subprogram and functional subprogram containing blocks of contiguous instructions before runtime. The fetch mechanism fetches flow-control instructions from the separated control-flow subprogram first and then fetches the other contiguous instructions from the functional subprogram in series or in parallel. The lookahead out-of-order i-fetch mechanism is viable for high-bandwidth accurate fetch by out-of-order and parallel fetching the flow-control and the other instructions of each basic block via the separated paths.

### TECHNICAL FILED OF THE DISCLOSURE

The invention relates creating a lookahead out-of-order (OoO) instruction fetch mechanism for dynamically determining control flow of program in advance by fetching flow-control instructions first and then by fetching blocks of contiguous instructions in basic blocks or fragments of basic blocks in a sequential and/or parallel manner, wherein the basic block is a straight-line code sequence with or without only branch in to the entry and with or without only branch out at the exit. In general, a basic block comprises of contiguous instructions followed by a flow-control instruction, comprising a branch instruction.

The invention relates generating separated control-flow subprogram (CFS) and functional subprogram (FS) from application software or compiled code of the application software before runtime, wherein the control-flow subprogram contains flow-control instructions found in basic blocks and temporary flow-control instructions representing fragments of the basic blocks: the functional subprogram contains non-flow-control instructions found in the basic blocks.

The invention relates performing lookahead operations by fetching a single or plurality of flow-control instructions from CFS to a branch prediction unit (BPU) if necessary and then fetching a single or plurality blocks of the contiguous instructions of the associated flow-control instructions from FS in the same or a cycle later to an instruction fetch unit (IFU): thereby, the BPU produces prediction results of the flow-control instructions in advance so that the blocks of the contiguous instructions from the unpredicted path cannot be fetched.

The lookahead operations in the invention include (1) lookahead branch prediction, (2) lookahead instruction prefetch, and (3) lookahead instruction fetch: the branch prediction, instruction prefetch, and instruction fetch are initiated a single or plurality cycles earlier than the operations initiated in prior arts.

The lookahead branch prediction is initiated by fetching only flow-control instructions that need to be predicted to the BPU before or at the same cycle of the first block of the contiguous instructions of the associated flow-control instructions. The BPU predicts a single or plurality of flow-control instructions (e.g., conditional branches) in order to dynamically determine control flow early or even before fetching instructions from the wrong path(s). The lookahead branch prediction overlaps latencies of branch predictions and fetch cycles of instructions in FS. Therefore, overall instruction fetch bandwidth is increased. The lookahead branch prediction enables to utilize a simple low-power BPU, which may take plurality cycles of branch prediction. Since at least a single or plurality cycles of advanced prediction for fetching instructions on dynamically determined control flow, the lookahead branch prediction prevents instruction cache (i-cache) pollution. Thereby, resilience of i-cache miss penalties is increase.

The lookahead prefetch in the invention prefetches a plurality of flow-control instructions in CFS without predicting dynamic control flow. Instead, only flow-control instructions in CFS are prefetched from fall-through and/or branch target locations if the branch target locations are obtained from the flow-control instructions prefetched. The blocks of the contiguous instructions in FS associated with the flow-control instructions prefetched in CFS are prefetched from fall-through and/or branch target locations in each i-cache miss. Aforementioned prefetch operations of the flow-control instructions and the associated blocks of the contiguous instructions are repeated one or more times whenever i-cache miss is occurred.

The lookahead prefetch in the invention prefetches a plurality of flow-control instructions in CFS with predicting dynamic control flow if a BPU is available. The flow-control instructions in CFS are prefetched according to the predicted locations and then start to prefetch blocks of the contiguous instructions in FS at the same or at the next prefetch cycle. Aforementioned prefetch operations of the flow-control instructions and the associated blocks of the contiguous instructions are repeated one or more times whenever i-cache miss is detected.

In the lookahead fetch in the invention, each instruction in CFS fetched represents a block of contiguous instructions, comprising a basic block or a fragment of a basic block. Therefore, fetching a plurality of flow-control instructions in CFS requires much less clock cycles and smaller size of storage in i-caches than fetching all instructions of the plurality of blocks in FS. The flow-control instructions in CFS are fetched a single or plurality of cycles ahead fetching blocks of the contiguous instructions in FS. Accordingly, cache misses of the plurality of blocks in FS are serviced at least a single or plurality of cycles early. The lookahead fetch allows utilizing simple and low-power hardware in the i-fetch mechanism. More specifically, entire contiguous instructions of each basic block or fragment stored in the upper-/lower-level (L1/L2) i-caches are accessed with only an initial address of the basic block or fragment and with the same speed if needed to enhance prefetch and fetch bandwidths.

The invention relates performing various loop operations by fetching a single or plurality of flow-control instructions in CFS to BPU and forwarding the instructions to a temporary buffer for reordering the instructions with the entire contiguous instructions of the basic blocks in FS already fetched to the temporary buffer, which can be used as an input buffer of instruction decoders (i-decoders). The temporary buffer is capable of operating as a loop buffer as well. This buffer continues to supply instructions in a plurality of loops to the i-decoders without fetching the instructions of the loops from i-caches again. Thereby, the entire instruction memory (i-memory) and i-caches are shut down during the loop operations for reducing power consumption.

The invention relates performing low-power i-fetch operations by employing simple, small, and low-power caches, which are accessed in parallel from different banks and fast enough to access L1 and L2 caches in a single cycle if necessary. More specifically, the blocks of the contiguous instructions of basic blocks or fragments are allocated to access in parallel.

The invention relates dynamically expanding size of basic blocks by fetching a single or plurality of the flow-control instructions in CFS in parallel and selectively discarding some flow-control instructions, which are not necessary to fetch to the BPU, wherein the discarded flow-control instructions, including jumps, callers, and callees. More specifically, the basic blocks are dynamically expanded without modifying instruction set and violating functional compatibility. Unlike the predicated approach in prior arts eliminates branches, the invention does not remove flow-control instructions from compiled code (e.g., callees can be removed), nor does it fetch unnecessary flow-control instructions (e.g., jumps, callers, and callees) to remaining of CPU. In addition, any branch prediction latency is diminished while concurrently fetching other instructions in basic blocks in the invention. Instead of executing operations of the two instructions in a predicated instruction (e.g., conditional branch and move operations in a predicated move instruction) in the same cycle, the invention executes each instruction separately and predicts the conditional branch earlier than the move operation need to be executed.

### BACKGROUND OF THE DISCLOSURE

The present invention generally relates separating instructions determining control flow from the other instructions in program. More specifically, basic blocks and fragments of basic blocks in the program are primarily used for producing two subprograms, comprising a control-flow subprogram (CFS) and functional subprogram (FS), wherein instructions in CFS provide information to dynamically determine control flow of the program and initial access address of the contiguous instructions associated basic blocks or fragments: the contiguous instructions in FS provide compatible operations.

The separated CFS contains two types of instructions, comprising flow and non-flow control instructions: the flow-control instructions found in basic blocks are modified for redirecting control flow to the target locations in CFS and to access contiguous instructions of the basic blocks in FS. The instructions in each subprogram are stored in concurrently accessible memories via the caches. Non-flow-control instructions, however, can be added into the separated CFS for parallel fetching if converted a basic block to multiple fragments of the basic blocks or if basic blocks do not include flow-control instructions.

Entire contiguous instructions of each basic block in FS are automatically fetched by asserting only an initial address to the memories or caches assigned for the FS. The contiguous instructions of the basic blocks are precisely fetch in parallel from our simple and low-power memories and/or caches to OoO CPUs.

The invented lookahead OoO i-fetch apparatus relates operating in the coarse granularity of basic blocks: more specifically, OoO fetches are performed only when the basic blocks include flow-control instructions comprising conditional branches that need to be predicted. This offers substantial benefits for enhancing i-fetch bandwidth and energy efficiency as well as provides viable alternatives of the aforementioned limitations of the OoO fetch paradigm in prior arts.

The invented lookahead OoO i-fetch apparatus relates branch-first out-of-order fetching a single or plurality of the flow-control instructions in CFS first and then fetching a single or plurality of the contiguous instructions in FS associated with the flow-control instructions at the same cycle or at a single or plurality of cycles later. More specifically, a single or plurality of the flow-control instructions that need to be predicted are fetched to a single or plurality of the BPUs so that a single or plurality of the contiguous instructions are fetched in sequential or parallel according to the dynamic control flow. Therefore, the flow-control instructions in CFS are fetched early enough not to fetch or significantly reduce a number of the contiguous instructions in FS from unpredicted paths that are dynamically determined. In addition, a single or plurality of the flow-control instructions fetched to a single or plurality of the BPUs are predicted at least a single or plurality of cycles early to hide branch prediction latencies and to replace complex expensive BPUs to simple and inexpensive BPUs.

The invented lookahead OoO i-fetch apparatus relates prefetching a single or plurality of the flow-control instructions from both of the fall-through path and predictable path if possible in a single or plurality times and then prefetching a single or plurality of the contiguous instructions from both of the fall-through path and predictable path if possible whenever i-cache miss is occurred. More specifically, a single or plurality of the i-cache misses of the flow-control instructions in CFS is detected generally at least a single or plurality of cycles earlier than detecting a single or plurality of the i-cache misses of the contiguous instructions in FS because a flow-control instruction represents a plurality of the contiguous instructions associated with it.

The invented lookahead OoO i-fetch apparatus relates selectively fetching a single or plurality of the flow-control instructions in CFS to a single or plurality of the BPUs in order to determine dynamic control flow by predicting the flow-control instructions fetched. A single or plurality of the contiguous instructions associated with the single or plurality of the flow-control instructions is fetched to an instruction queue via a plurality of entries in parallel at the same or at least one or more cycles later according to the dynamic control flow determined.

More specifically, a flow-control instruction in CFS and the contiguous instructions associated with the flow-control instruction of the same basic block are fetched in out-of-order. The lookahead OoO i-fetch of the flow-control instructions are predicted by BPU and then reordered to determine the branch behavior by the backend CPU. Therefore, a plurality of i-fetch stages implemented in the OoO CPUs in prior arts can even be a single fetch stage without pre-decoding the fetched instructions to determine whether the instructions are forwarded to BPU or not. In addition, a single or plurality of fetches is resumed whenever any disrupted operations, including branch miss prediction and interrupts/exceptions, that temporarily postpone current operations or permanently discarded on-going operations, change control flow.

The invented lookahead OoO i-fetch apparatus relates recoupling the flow-control instructions fetched to BPU to the entire contiguous instructions of the associated basic blocks from the instruction queue in the same program order before separating the control flow. The recoupled and reordered contiguous instructions and a flow-control instruction of a basic block are stored to a plurality of entries of a reorder buffer, which can be used as an input buffer of instruction decoders (i-decoders).

An expanded reorder buffer is capable of operating as a simple loop buffer, which continues to supply instructions in a plurality of loops to the decoders without fetching the instructions of the loops from i-caches again. Therefore, the entire i-memory and i-caches can be shut down during the loop operations for reducing power consumption as loop buffers found in prior arts.

The invented lookahead OoO i-fetch apparatus relates reducing power consumption of i-caches without deceasing i-fetch performance, unlike multi-level i-caches in prior arts increase leakage power consumption due to occupying a substantial space of chip and increase dynamic power consumption owing to access the i-caches every cycles. The invention reduces power consumption of i-caches by utilizing the invented small, simple, and low-power i-caches.

The smaller caches generally introduce the higher cache misses. However, the resilience of i-caches miss can be increased by continuous fetching and executing instructions beyond a cache miss and by overlapping a plurality of i-cache misses at the same cycles. In the invention, instructions in CFS and FS are fetched via the invented upper-/lower-level i-caches enhance resilience of i-cache misses because size of the separated CFS are significantly reduced. The reduced size of the CFS permits detecting any i-cache miss before detecting misses of contiguous instructions in FS from the i-caches for FS. In addition, the upper-level i-caches comprising of a plurality of banks are smaller than the upper-level i-caches used in prior arts and are as fast as the lower-level i-caches in the invention. These differences contribute additional resilience of i-cache misses and related stalls during the i-fetch.

### Problems of the Art

Contemporary OoO CPUs need high-bandwidth i-fetch for concurrently operating functional units in each cycle. In order to satisfy the demand, wide i-fetching has been used. Accordingly, i-fetch window size and i-cache block size have been increased. However, i-caches are restricted to fetch more than a certain number (e.g., eight) of instructions per cycle because of taken branches every the certain number of instructions on average [1]. In the invented i-fetch apparatus, i-fetch window size and i-cache block size is reduced and overheads of frequent branches, including delay and power consumption, are eliminated.

In prior arts, almost half of the instructions prefetched via a four instruction wide i-fetch scheme are discarded. Three quarters of the instructions prefetched are not used if an eight instruction wide mechanism is employed. Consequently, 61% of instructions fetched to a CPU were not executed due to the taken branches and the less accurate i-fetch mechanism with MiBench [2]. The invented i-fetch apparatus permits not to fetch any unnecessary instructions due to the misaligned i-cache block size and boundary of basic blocks.

Instead of fetching a large block of contiguous instructions, parallel i-fetching of different traces were introduced. A plurality of branches is predicted in each cycle to fetch instructions from different traces predicted by the complex branch predictor [3] in prior arts. A complex i-cache was introduced to supply a plurality of non-contiguous blocks per cycle [4] in prior arts. In the invented i-fetch apparatus, a plurality of branches is predicted to dynamically determine control flow and then instructions from different basic blocks on the control flow are fetched in parallel.

In prior arts, the instructions in loops or in dynamic execution order are retrieved during the execution after storing them to storages, comprising loop buffers and trace caches [5, 6, 7] rather than fetching them repeatedly. Although both of trace caches and loop buffers offer high-bandwidth i-fetch capability, their inefficient usage of cache space and possibly increasing cache miss rates are concerned [8]. Analysis of an ideal loop buffer for holding 32 instructions shows that 24 to 90% of all instruction accesses can be dynamically captured across SPEC2006, MiBench, and SD-VBS [9]. Many embedded loop buffers in pipelines in prior arts have been implemented for reducing the fetch and decode operations of the frontend pipelines by storing considerably large loops [10, 11, 12]. Therefore, trace caches/loop buffers are brute force solutions of high-bandwidth i-fetch owing to expensive area requirements caused by inefficient utilization of cache/buffer space. In the invented i-fetch apparatus, a plurality of loops is fetched and stored in expanded input buffer of the instruction decoders. The instructions stored in this buffer can be reused once loop operations are detected.

U.S. Pat. No. 8,245,208 [13] presents to generate loop code to execute on single-instruction multiple-datapath architecture.

In U.S. Pat. No. 7,181,597 [14], the first instruction is decoded into a single or plurality of operations with a decoder. The decoder passes the first copy of the operations to a build engine associated with a trace cache. The decoder also directly passes the second copy of the operation to a backend allocation module in a decoder to enhance performance by selectively bypassing a trace cache build engine.

An on-chip instruction trace cache presented in U.S. Pat. No. 6,167,536 [15] is capable of providing information for reconstructing instruction execution flow. More specifically, the instructions disrupting the instruction flow by branches, subroutines, and data dependencies are presented. This approach allows less expensive external capture hardware to be utilized and also alleviates various bandwidth and clock synchronization issues confronting many existing solutions.

In prior arts, a sequence of instructions fetched are not executed the same order by OoO CPUs. For instance, those critical instructions ordered early in dataflow from different traces need to be fetched and executed prior to the remaining instructions in the traces. There is also significant parallelism exists between instructions of different traces [16]. Instead of consecutive fetching of traces, small blocks of instructions from multiple points in a program are fetched for improving i-fetch bandwidth and evaluating resilience of i-cache misses by concurrently operating multiple sequencers and renaming units [17, 18]. Despite of high i-fetch throughput of the approach in prior arts, overheads of hardware and operational power consumption of the concurrently operating multiple sequencers and renaming units need to be evaluated for the current low-power high-performance CPUs. In the invented i-fetch apparatus, a plurality of basic blocks identified on dynamic control flow is fetched in parallel without employing a plurality of program counters and sequencers. In addition, small, simple, and low-power i-caches are utilized and integrated for concurrent accessing instructions from a plurality of different entries under the i-cache miss resilience scheme established in the invented lookahead OoO i-fetch apparatus via the separated control flow.

In U.S. Pat. No. 6,047,368 [19], an instruction packing apparatus is capable of concurrently issuing and executing the dynamical packing and identifying of assigned functionalities of the assembled instructions. A compatibility circuit including translation and grouper circuits where the translation and grouper circuits, respectively, is claimed. The circuits transform old instructions to new instructions as simpler forms and group instructions based on instruction type by hardware when transferring a cache block from the memory to the cache. This approach, however, focuses only on increasing instruction level parallelism while paying additional hardware cost, but still requires at least the same or more instruction cache.

U.S. Pat. No. 5,509,130 [20] describes that instructions are packed and issued simultaneously per clock cycle for execution. An instruction queue stores sequential instructions of a program and branch target instruction(s) of the program, both of which are fetched from the instruction cache. The instruction control unit decodes the sequential instructions, detects operands cascading from instruction to instruction, and groups instructions according to a number of exclusion rules which reflect the resource characteristics and the processor structure. Since instructions are grouped after fetching sequential instructions from the instruction cache, it still requires involving branch prediction and resolution units for branch instructions because of packing at runtime.

U.S. Pat. No. 5,999,739 [21] presents a procedure to eliminate redundant conditional branch statements from a program.

Server processors in prior arts access their branch predictors every cycle [22]. Consequently, the branch predictor accounts for up to 15% of CPU power consumption. Therefore, power consumption and multi-cycle latency of branch predictions must be dealt with as important parts of the new i-fetch paradigm as criticized in [22]. Since i-fetching approaches in prior arts are not sufficient, especially as the demands on high parallel executions and low-power operations are increased, a new low-power high-throughput i-fetch paradigm has been essential. Thereby, it is ideal to fetch all of the instructions in each basic block according to a sequence of dynamic basic blocks without wasting fetch slots while effectively handling latency and precise access of a branch predictor. In the invented i-fetch apparatus, a basic-block-based compilation transforms random structured control-flow programs to the separated control-flow programs for mapping well onto a sequential memory addressing order. Accordingly, the invented i-fetch apparatus is capable of accurately fetching a single or plurality of flow-control instructions to a single or plurality of BPUs before concurrently supplying a plurality of fragmented blocks of other instructions of basic blocks to instruction decoders in an OoO CPU. The invented i-fetch apparatus achieves higher i-fetch bandwidth and lower power consumption than known sequential and/or parallel frontend CPUs, including i-caches, in prior arts.

Instruction prefetching is complicated and implemented as hardware [23, 24] unlike data prefetching. Since i-prefetching accuracy is an important factor to mitigate i-cache pollution, often i-prefetchers employ branch predictors to achieve further alleviation of i-fetch bandwidth [25, 26]. Existing lookahead prefetching, however, is still limited by branch prediction bandwidth. The invented i-fetch apparatus performs the lookahead prefetch both with and without BPUs. In order to increase a lookahead i-prefetching capability, the branch targets are obtained from the flow-control instructions modified during the control flow separating process.

In addition, a plurality of blocks of contiguous instructions from a plurality of different basic blocks are prefetched and fetched in parallel by allocating the blocks of contiguous instructions from the different basic blocks to the concurrently accessible blocks of the i-caches regardless of the order of the instructions in the program before separating control flow from the program. Therefore, resilience of i-cache miss is increased. I-cache pollution is reduced although small sizes of i-caches are utilized.

### SUMMARY OF THE DISCLOSURE

The invention generally relates to a processor system comprising a software compilation for separating control flow from program and generating a control flow subprogram (CFS) and a functional subprogram (FS) and a lookahead out-of-order (OoO) instruction fetch (i-fetch) fronted processor integrated an in-order or OoO backend processor found in prior arts. More specifically, the lookahead OoO i-fetch fronted processor comprises of a separated instruction memory (i-memory) system comprising a single or plurality of CFS memory system, FS memory system, and FS address units, a lookahead OoO i-fetch frontend processor comprising a CFS prefetcher, a FS prefetcher, a CFS fetcher, a FS fetcher, and a single or plurality of branch prediction units (BPUs) integrated with a CFS queue for holding a single or plurality of flow-control instructions, a FS fetch queue for storing a single or plurality of blocks of contiguous instructions, a CFS program counter, a FS program counter, and a reorder decode buffer for reordering contiguous instructions fetched from FS and flow-control instructions fetched from CFS via the BPUs and supplying reordered instructions to a single or plurality of instruction decoders, and other units typically found in an in-order or OoO backend processor in prior arts.

The control-flow separating compilation identifies various types of the basic blocks in the program, comprising an assembly program, typically generated by conventional compiler in prior arts and generates a CFS and a FS for fetching instructions in a lookahead and OoO manner while offering compatibility of the program. The CFS contains flow-control instructions found in basic blocks. The control-flow separating compilation also creates non-flow-control instructions in CFS for fragmenting basic blocks in to blocks of contiguous instructions. The FS contains contiguous instructions of each basic block or a fragment of a basic block. A flow-control instruction or a non-flow-control instruction in CFS is associated with a block of contiguous instructions in FS.

Therefore, the lookahead OoO i-fetch performs lookahead operations, (1) lookahead OoO prefetch with or without branch prediction according to the demanded resilience of i-cache miss latencies, (2) lookahead OoO branch prediction with a single or plurality of BPUs according to the necessitated i-fetch parallelism for determining control flow early and hiding BPU latency, (3) lookahead OoO fetch with a single or plurality of BPUs according to the required i-fetch bandwidth and dynamic basic block expansion, and (4) lookahead loop operations for low-power and high-performance computing, (5) low-power and high-resilience i-cache systems implemented with small, simple, and low-power and caches, and (6) the other operations useful in processor.

The lookahead OoO i-fetch frontend processor is integrated with a single or plurality of CFS and FS memory systems integrated with a single or plurality of FS address units. The single or plurality of CFS and FS memory systems comprises a single or plurality of banks of main memory, and a single or plurality of levels of caches, comprising upper- and/or lower-level caches. More specifically, the CFS and FS caches comprise a single or plurality of banks of caches for parallel access.

The single or plurality of FS address units comprises a single or plurality of CFS instruction decoder and a single or plurality of FS address generator integrated with a single or plurality of address counters. The CFS decoder extracts address information from the instructions received from the CFS memory system. The FS address generator produces an initial address of the contiguous instructions associated with the decoded instruction in CFS. The address counter and associated hardware units assist the FS address generator to continuously generate a next address of a single instruction in FS or a single block of contiguous instructions.

The lookahead OoO i-fetch frontend processor comprises of a pair of the CFS and FS prefetchers and a pair of the CFS and FS fetchers, a single or plurality of BPUs with a CFS queue connected to a CFS program counter, a FS fetch queue connected to a FS program counter, and a reorder decode buffer.

The CFS prefetcher prefetches a single or plurality of flow-control instructions and temporary non-flow-control instructions in CFS from the CFS main memories to the lower- and/or the upper-level CFS i-caches in sequence or parallel when any level of the CFS i-caches are missed. In addition, the CFS prefetcher prefetches a single or plurality of the instructions in CFS from the lower-level CFS i-caches to the upper-level CFS i-caches in sequence or parallel when the lower-level CFS i-caches are missed. More specifically, the CFS prefetcher prefetches the instructions in CFS without predicting dynamic control flow. Instead, only flow-control instructions in CFS are prefetched from fall-through and/or branch target locations if the branch target locations are obtained from the flow-control instructions prefetched. More specifically, the CFS prefetcher iteratively prefetches a number of the instructions in CFS one or more times whenever CFS i-cache miss is occurred.

The FS prefetcher prefetches a single or plurality of blocks of contiguous instructions in FS from the FS main memories to the lower- and/or the upper-level FS i-caches in sequence or parallel when any level of the FS i-caches are missed. In addition, the FS prefetcher prefetches a single or plurality of the instructions in FS from the lower-level FS i-caches to the upper-level FS i-caches in sequence or parallel when the lower-level FS i-caches are missed. More specifically, the FS prefetcher iteratively prefetches a number of the blocks of the contiguous instructions one or more times whenever FS i-cache miss is occurred. Preferably, a number of the consecutive FS prefetches are less than a number of the consecutive the CFS prefetches. The FS prefetcher stops prefetches the contiguous instructions after prefetching the last instruction of the contiguous instructions.

The CFS fetcher fetches a single or plurality of instructions in CFS from the upper-level CFS i-caches to a single or plurality of BPUs in sequence or parallel. The instructions fetched are stored to a CFS queue, which has a single or plurality of entries to access the instructions fetched to the BPUs. The CFS fetcher initiates the CFS prefetch operation when the lower-level of the CFS i-caches are missed. More specifically, the CFS fetcher decides which instruction in CFS is fetched to the BPU according to perform branch prediction of the fetched flow-control instruction. More specifically, a flow-control instruction in CFS and the contiguous instructions associated with the flow-control instruction of the same basic block are fetched in out-of-order.

The FS fetcher fetches a single or plurality of blocks of contiguous instructions in FS from the upper-level FS i-caches to the FS fetch queue in sequence or parallel, wherein the FS fetch queue has a single or plurality of entries to access instructions in FS. More specifically, the FS fetcher initiates to fetch a single or plurality of blocks of the contiguous instructions associated with the flow-control instruction in CFS fetched whether or not to BPU. The FS fetcher stops fetches the contiguous instructions after fetching the last instruction of the contiguous instructions.

The CFS prefetcher, the FS prefetcher, the CFS fetcher, and the FS fetcher concurrently operate if needed. The CFS prefetcher and the CFS fetcher also prefetcher and fetches instructions in CFS sequentially and the FS prefetcher and the FS fetcher prefetcher and fetches instructions in FS concurrently while both of the instructions in CFS and the instructions in FS are prefetched and fetched concurrently. Therefore, the CFS prefetcher and the FS prefetcher perform the lookahead prefetch operations to alleviate the i-cache accessing latencies due to the cache traffic and pollution.

A single or plurality of the flow-control instructions stored in the CFS queue is utilized for predicting branches and obtaining branch target addresses by a single or plurality of BPUs. The BPUs produce prediction results while fetching the contiguous instructions associated with the predicted instruction. More specifically, one or more flow-control instructions can be predicted while fetching the contiguous instructions associated with the previous flow-control instruction because a number of contiguous instructions are many more and take many more fetch cycles than a number of fetch cycles of one or a few (i.e., three or four) flow-control instructions in CFS fetched and predicted. Therefore, it is viable to determine dynamic control flow with the lookahead OoO fetch operations. This also results in (1) avoiding a number of blocks of the contiguous instructions fetched from the wrong paths, (2) expanding basic blocks dynamically, (3) increasing resilience of i-cache miss latency, (4) reducing i-cache pollution, (5) permitting to employ small, simple, and low-power i-caches, (6) eliminating unnecessary accesses and operations, including predecoding instruction fetched to access BPU and expanding i-fetch stages in the frontend pipeline, and (7) eventually achieving low-power and high-bandwidth i-fetch for the highly parallelized OoO speculative backend processors and low-power in-order backend processors in prior arts.

There has thus been outlined, rather broadly, some of the features of the invention in order that the detailed description thereof may be better understood, and that the present contribution to the art may be better appreciated. Additional features of the invention will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide the lookahead OoO i-fetch apparatus that improves the performance and power consumption of the lookahead OoO processor, including the achievement of lookahead OoO branch prediction and lookahead OoO prefetch and/or fetch of instructions in separated CFS and FS, for enhanced processor throughput while maintaining compatibility of the software.

An object is to provide the control-flow separating compilation that transforms the instructions in the software program and/or assembly code into CFS and FS. Alternatively, the CFS and FS can also be generated by a single compilation that includes the same instruction assembling capability as the invented system. The control-flow separating compilation identifies basic blocks and/or fragments of basic blocks to CFS and/or FS. The flow-control instructions and temporary non-flow-control instructions in CFS are modified from the existing instructions or composed by assigning different opcodes and other information to the instructions in CFS if needed.

Another object is to provide the control-flow separating compilation that eliminates and/or hides branch instructions that are not required to predict branch behavior and to obtaining branch target address while the program is executed by a processor.

Another object is to provide the control-flow separating compilation that composes compatible forms of the flow-control instructions and temporary non-flow-control instructions in CFS and contiguous instructions in FS associated with the instructions in CFS for preventing malicious usage and illegal copying of various software programs while providing compatibility of the software programs to the lookahead OoO processor.

An object is to provide the lookahead OoO i-fetch apparatus that decodes the flow-control instructions and temporary non-flow-control instructions in CFS for prefetching and fetching the blocks of the contiguous instructions associated with the instructions in CFS stored in dedicated, separate regions of distinct addresses in a single or plurality of the CFS memories and/or the CFS i-caches for sequential or parallel accesses.

Another object is to provide the lookahead OoO i-fetch apparatus that obtains an initial accessing address of the contiguous instructions after decoding the flow-control instruction associated with in CFS and continues to prefetch and/or fetch the remaining contiguous instructions until the last instruction of the contiguous instructions.

Another object is to provide the lookahead OoO i-fetch apparatus that prefetches a single or plurality of the instructions in CFS from the next prospective addresses, comprising the next instruction in CFS at the branch target address on dynamic control flow if the branch target address is obtainable and/or the next instruction in CFS at the fall-through path, whenever prefetching an instruction in CFS.

Another object is to provide the lookahead OoO i-fetch apparatus that provides a way to satisfy the CFS and FS i-cache usage and to reduce branch prediction and i-cache access latencies through the invented lookahead, OoO, pipelined, and parallel prefetch and fetch, unlike parallel i-fetch implemented in processors in prior arts.

Another object is to provide the lookahead OoO i-fetch apparatus that utilizes instructions in CFS to prefetch the single or plurality of instructions in CFS and/or instructions in FS on dynamic control flow, unlike the processors in prior arts prefetch and fetch a certain number of blocks of congruous instructions, but not be executed and discarded.

Another object is to separate a single or plurality of instructions in a basic block from the program if the single or plurality of instructions in a basic block needs to be prefetched and/or fetched out-of-order. For instance, the instructions in dataflow from different basic blocks are separated. Therefore, the instructions in dataflow from different basic blocks that need to be fetched for being executed prior to the other instructions in the basic blocks, are fetched in a lookahead and OoO manner.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called, however, to the fact that the drawings are illustrative only, and that changes may be made in the specific construction illustrated and described within the scope of this application.

### BRIEF DESCRIPTION OF THE DRAWINGS

A more complete understanding of embodiments of the disclosure will be apparent from the detailed description taken in conjunction with the accompanying drawings in which:

FIG. 1 is a diagram showing one embodiment of the lookahead OoO i-fetch apparatus for a control-flow separating compilation system comprising of a conventional compilation of application software in prior arts, an identifier for distinguishing and analyzing a plurality of basic blocks in the compiled program, a separated control-flow subprogram (CFS) compiler for generating CFS from the basic blocks, wherein the CFS comprising flow-control instructions and non-flow-control instructions representing basic blocks and fragments of the basic blocks, and a functional subprogram (FS) compiler for generating FS from contiguous instructions of the basic blocks and fragments of the basic blocks, wherein the contiguous instructions of the basic blocks without flow-control instructions and contiguous instructions of fragments of the basic blocks. Similar to the CFS and FS separating compilation shown in FIG. 1, a single or plurality of instructions in a basic block is additionally separated from the program if the single or plurality of instructions in a basic block needs to be prefetched and/or fetched out-of-order. For instance, the instructions ordered in dataflow from different basic blocks are separated. Therefore, the instructions ordered in dataflow from different basic blocks that need to be fetched for being executed prior to the other instructions in the basic blocks, are fetched in a lookahead and OoO manner.

FIG. 1 is also a diagram showing one embodiment of the generation method of two separated subprograms, CFS and FS, from various basic blocks found in the program. Different types of basic blocks are classified as a block of contiguous instructions without a flow-control instruction, a block of contiguous instructions with a flow-control instruction, a flow-control instruction, and fragments of a basic block, wherein (1) the block of contiguous instructions without a flow-control instruction is to create a temporary non-flow-control instruction in CFS and to assign the entire contiguous instructions of the basic block in FS, (2) the block of contiguous instructions with a flow-control instruction is to modify the flow-control instruction in CFS for determining dynamic control flow and for accessing the contiguous instructions in FS, and to assign the contiguous instructions of the basic block in FS excluding the flow-control instruction in CFS, (3) the same type of a basic block, comprising a subroutine, does not assign any instruction in CFS, but assign the contiguous instructions of the basic block in FS excluding the flow-control instruction, comprising a callee, (4) the basic block is fragmented to fetch in parallel with high bandwidth: fragments with and without a flow-control instruction are separated as two different types of small basic blocks;

FIG. 2 is a diagram showing one embodiment of the lookahead OoO i-fetch method for prefetching instructions from the separated CFS and the FS concurrently in a lookahead OoO manner without branch prediction by prefetching a number of instructions in CFS (i.e., three or four instructions) from both a fall-through path and a branched path or from only a fall-through path if an address of the branched path is not obtainable whenever any CFS i-cache miss is detected, by prefetching a single or plurality of blocks of contiguous instructions associated with a number of basic blocks in sequential or parallel until the last instruction of the contiguous instructions associated with each basic block is prefetched, and by repeating another lookahead OoO prefetch operations whenever a CFS or FS i-cache miss is detected.

FIG. 2 is also a diagram showing one embodiment of the lookahead OoO i-fetch method for fetching instructions from the separated CFS and the FS concurrently in a lookahead OoO manner with a plurality of branch predictions by fetching a number of consecutive instructions in CFS (i.e., three instructions) to a plurality of BPUs for dynamically determining control flow as early as possible to avoid fetching unnecessary contiguous instructions from the wrong path, by discarding a single or plurality of the flow-control instructions fetched if the prior flow-control instruction in the CFS program order is predicted to take a branch, by resuming to fetch the number of instructions in CFS from the branched address, by fetching a single or plurality of blocks of contiguous instructions associated with a number of basic blocks in sequential or parallel until the last instruction of the contiguous instructions associated with each basic block is fetched, and by repeating another lookahead OoO fetch operations whenever a CFS or FS i-cache miss is detected; and

FIG. 3 is a diagram showing one embodiment of the lookahead OoO i-fetch apparatus for predicting instructions fetched from the separated CFS with a BPU first and for starting to concurrently fetch a plurality of blocks of the contiguous instructions in FS associated with the instruction predicted at the same cycle or at least a cycle later, wherein the BPU takes an extra cycle delay for each branch prediction, all of the instructions in a loop comprising of a plurality of basic blocks (e.g., four basic blocks) are fetched within seven cycles: four flow-control instructions in CFS take seven cycles, comprising three BPU delays, but 36 instructions in four contiguous instructions also take seven cycles when fetching two blocks of three contiguous instructions in each block. Therefore, the instructions, which will be executed, are fetched accurately without fetching unnecessary instructions from the wrong path or fetching entire instructions stored in the same i-cache block, which comprises instructions in different basic blocks.

FIG. 3 is also a diagram showing one embodiment of the lookahead OoO i-fetch-based in-order or OoO processor system comprising a separated instruction memory system, a lookahead OoO frontend processor, and a backend processor found in prior arts (1) for prefetching and fetching a single or plurality of the instructions in separated CFS and FS via the separated instruction memory system in a lookahead and OoO manner, (2) for predicting flow-control instructions in CFS fetched to a single or plurality of the BPUs while a single or plurality of blocks of contiguous instructions in FS are fetched to a FS fetch queue, (3) for reordering the instructions fetched out of order and stored in the CFS queue and the FE fetch queue via the separated CFS and FS memory systems in parallel, (4) for continuously forwarding the reordered instructions to the next stage, the single or plurality of instruction decoders, (5) for handling disrupted operations, including branch miss predictions, interrupts, and exceptions, with a CFS program counter, a FS program counter, and other components shown, and (6) for maintaining compatibility of the program in prior arts and for enhancing performance and operational energy efficiency with the backend processor.

### DETAILED DESCRIPTION OF EXAMPLE EMBODIMENTS

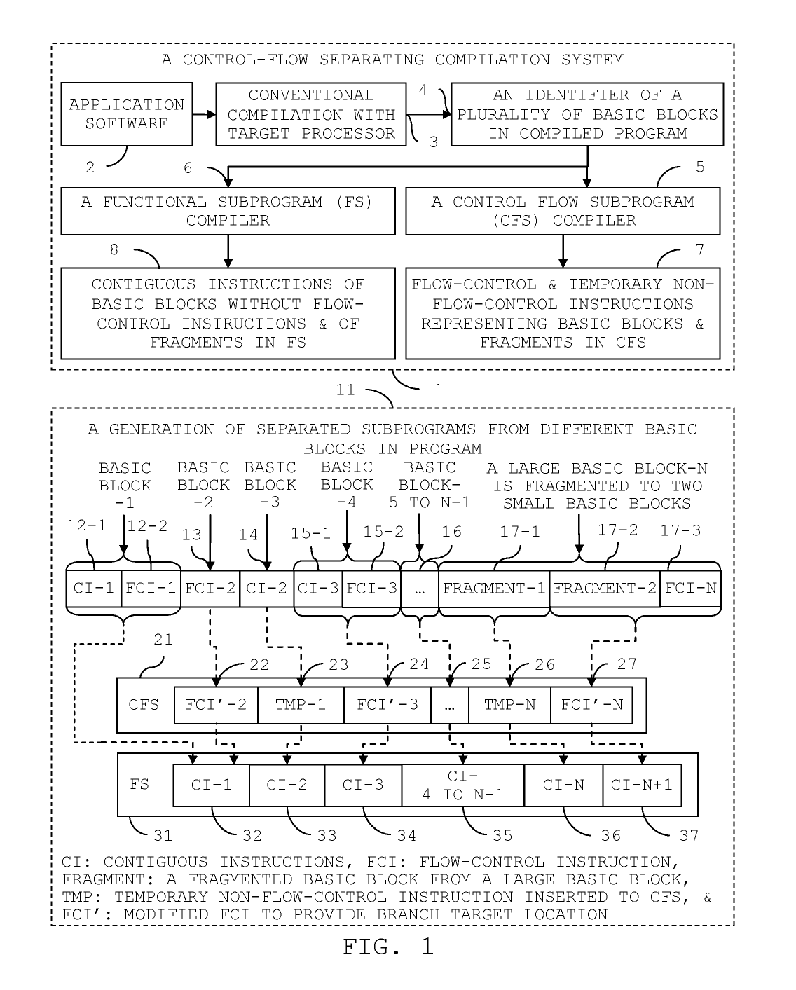

FIG. 1 is a diagram showing one embodiment of the lookahead OoO i-fetch apparatus for a control-flow separating compilation system 1 comprising a conventional compilation 3 of application software 2 in prior arts, an identifier for distinguishing and analyzing different types and sizes of a plurality of basic blocks in the compiled program 4, and a control-flow subprogram (CFS) compiler 5 for separating control flow from the contiguous instructions of the basic blocks, wherein the CFS 7 comprises flow-control instructions and non-flow-control instructions representing basic blocks and fragments of the basic blocks, and the functional subprogram (FS) compiler 6 for generating contiguous instructions of basic blocks without flow-control instructions and contiguous instructions of fragments of the basic blocks in FS 8.

In one embodiment, the separated subprograms, CFS 7 and FS 8, from various basic blocks found in the program are compiled by the control-flow separating compilation system. Wherein different types of basic blocks are classified as a block of contiguous instructions without a flow-control instruction 14, a block of contiguous instructions 12-1, 15-1 with a flow-control instruction 12-2, 15-2, a flow-control instruction 13, and fragments 17-1, 17-2, 17-3 of a basic block, wherein (1) the block of contiguous instructions without a flow-control instruction 14 is to create a temporary non-flow-control instruction 23 in CFS 21 and to assign the entire contiguous instructions 33 of the basic block in FS 31, (2) the block of contiguous instructions 15-1 with a flow-control instruction 15-2 is to modify the flow-control instruction 24 in CFS 21 for determining dynamic control flow and for accessing the contiguous instructions 34 in FS 31, and to assign the contiguous instructions 34 of the basic block in FS excluding the flow-control instruction 24 in CFS 21, (3) the same type of a basic block 12-1, 12-2, comprising a subroutine, does not assign any instruction in CFS, but assign the contiguous instructions 32 of the basic block in FS 31 excluding the flow-control instruction 12-2, comprising a callee, (4) the basic block 17-1, 17-2, 17-3 is fragmented to fetch in parallel with high bandwidth: fragments with a flow-control instruction 17-2, 17-3 and without a flow-control instruction 17-1 are separated as two different types of small basic blocks, which are represented by a temporary non-flow-control instruction 26 and a modified flow-control instruction 27 in CFS 21, and are accessed by two contiguous instructions 36, 37, (5) a flow-control instruction 13, comprising a caller, is separated as a modified flow-control instruction 22, but no instruction is created in FS 31 and directly accesses contiguous instructions of the subroutine in FS 31, and (6) a plurality of basic blocks 16 is separated as a plurality of instructions 25 in CFS 21 and a plurality of blocks of contiguous instructions 35 in FS 31. The presented separated subprogram generation from basic blocks in program is not limited in its application to the details of construction or to the arrangements of the components set forth in the above description or illustrated in FIG. 1.

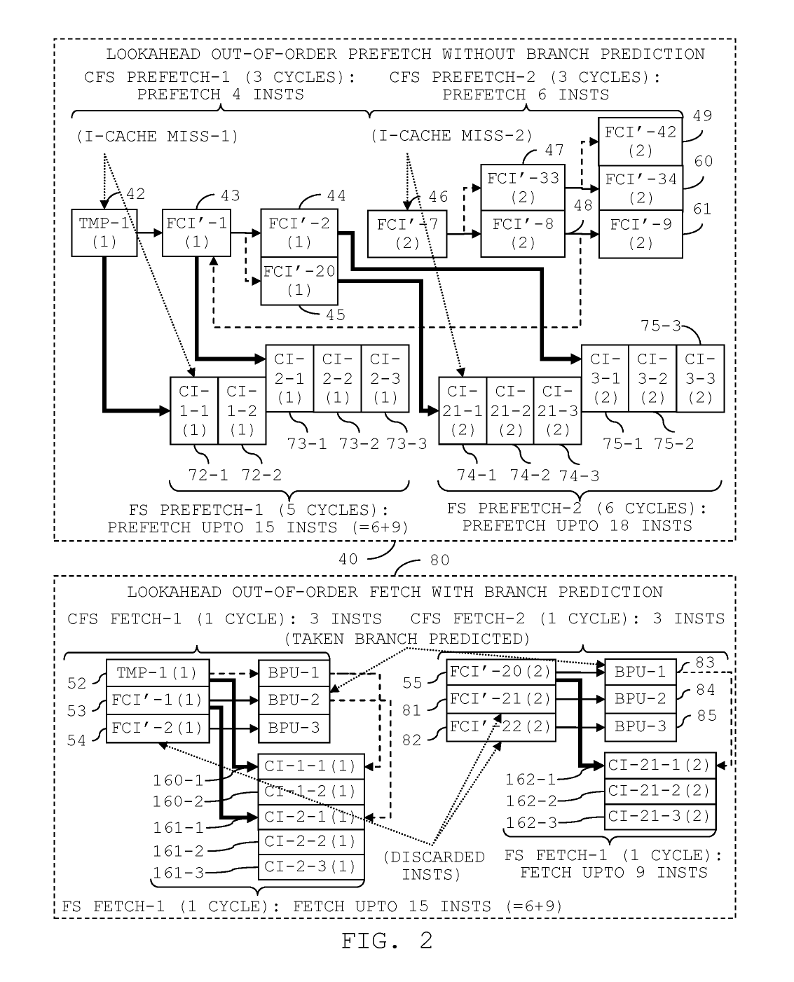

FIG. 2 is a diagram showing one embodiment of the lookahead OoO i-fetch method for prefetching instructions from the separated CFS and the FS concurrently in a lookahead OoO manner without branch prediction 40 by prefetching a number of instructions in CFS 42, 43, 44, 45 (i.e., three or four instructions) from both a fall-through path 44, 48, 60 and a branched path 45, 47, 49 or from only a fall-through path 61 if an address of the branched path is not obtained whenever any CFS i-cache miss is detected, by prefetching a single or plurality of blocks of contiguous instructions associated with a number of basic blocks 72-1, 72-2, 73-1, 73-2, 73-3, 74-1, 74-2, 74-3, 75-1, 75-2, 75-3 in sequential or parallel until the last instruction of the contiguous instructions associated with each basic block 72-2, 73-3, 74-3, 75-3 is prefetched, and by repeating another lookahead OoO prefetch operations 42, 72-1, 46, 74-1 whenever a CFS or FS i-cache miss is detected. The presented lookahead OoO prefetch is not limited in its application to the details of construction or to the arrangements of the components set forth in the above description or illustrated in FIG. 2.

In one embodiment, the lookahead OoO i-fetch method for fetching instructions from the separated CFS and the FS concurrently in a lookahead OoO manner with a plurality of branch predictions by fetching a number of consecutive instructions in CFS 52, 53, 54 to a plurality of BPUs 83, 84, 85 for dynamically determining control flow as early as possible to avoid fetching unnecessary contiguous instructions from the wrong path, by discarding a single or plurality of the flow-control instructions 54, 81, 82 fetched if the prior flow-control instruction 53, 55 in the CFS program order is predicted to take a branch, by resuming to fetch the number of instructions in CFS from the branched address, by fetching a single or plurality of blocks of contiguous instructions 160-1, 160-2, 161-1, 161-2, 161-3, 162-1, 162-2, 162-3 associated with a number of basic blocks in sequential or parallel until the last instruction of the contiguous instructions associated with each basic block is fetched, and by repeating another lookahead OoO fetch operations whenever a CFS or FS i-cache miss is detected. The presented lookahead OoO fetch is not limited in its application to the details of construction or to the arrangements of the components set forth in the above description or illustrated in FIG. 2.

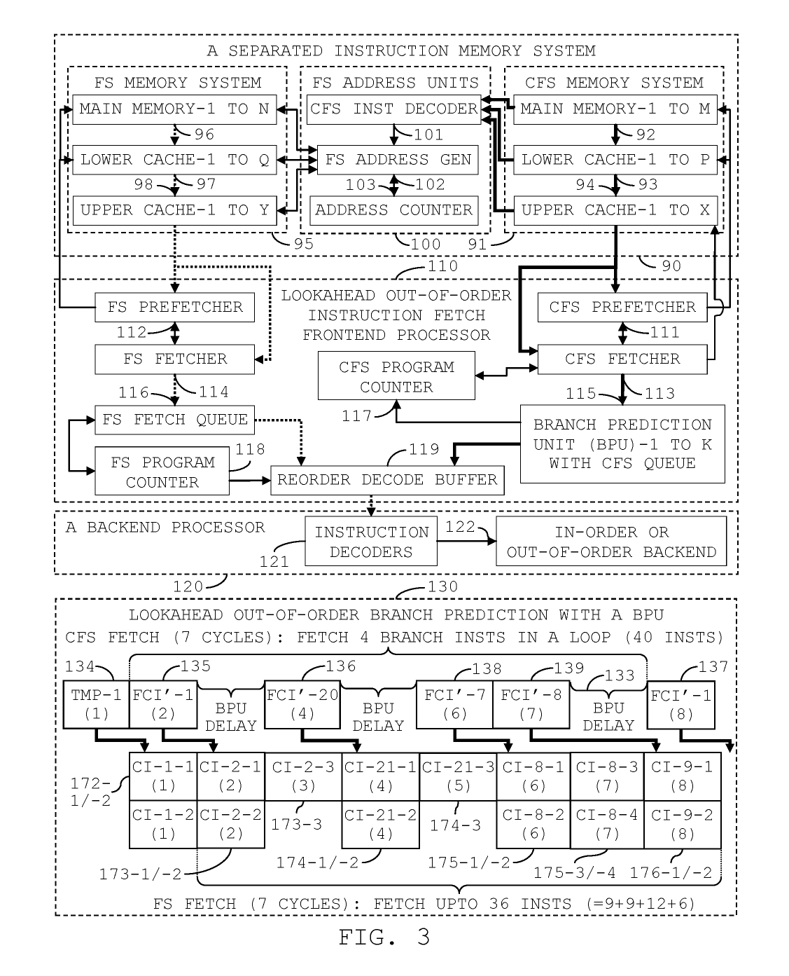

FIG. 3 is a diagram showing one embodiment of the lookahead OoO i-fetch apparatus for predicting instructions fetched from the separated CFS with a BPU first and for starting to concurrently fetch a plurality of blocks of the contiguous instructions in FS associated with the instruction predicted at the same cycle or at least a cycle later 130, wherein the BPU takes an extra cycle delay for each branch prediction 133, all of the instructions (e.g., 40 instructions is equal to the sum of 4 instructions in CFS and 36 instructions in FS) in a loop comprising a plurality of basic blocks (e.g., four basic blocks) are fetched within seven cycles: four flow-control instructions in CFS 135, 136, 138, 139 take seven cycles, comprising three BPU delays. Four contiguous instructions comprising 36 instructions 173-1/-2, 173-3, 174-1/-2, 174-3, 175-1/-2, 175-3/-4, 176-1/-2 take seven cycles when fetching two blocks of three contiguous instructions in each block 173-3.

In one embodiment, a block of contiguous instructions in FS contain a fixed number of instructions from one instruction to a plurality of instructions according to i-fetch parallelism implemented in the target processor system. The last block of the contiguous instructions of each basic block in FS may contains a variable number of instructions if a number of the remaining instructions of the basic block are less than the number of instructions contained in a block, excluding the last block. A delimiter that separates two consecutive basic blocks is used for distinguish the last block. The presented accurate prefetch and fetch operations of contiguous instructions in a block is not limited in its application to the details of construction or to the arrangements of the components set forth in the above description.

In one embodiment, the instructions, which will be executed, are fetched accurately without fetching unnecessary instructions from the wrong path or fetching entire instructions stored in the same i-cache block comprising instructions in different basic blocks.

FIG. 3 is also a diagram showing one embodiment of the lookahead OoO i-fetch apparatus for developing the lookahead OoO i-fetch-based in-order or OoO processor system 90, 110, 120. The lookahead OoO i-fetch-based in-order or OoO processor system 90, 110, 120 comprising a separated instruction memory system 90, a lookahead OoO frontend processor 110, and a backend processor 120 found in prior arts for prefetching and fetching a single or plurality of the instructions in separated CFS and FS via the separated instruction memory system 90 in a lookahead and OoO manner.

In one embodiment, the separated instruction memory system 90 comprises a single or plurality of CFS memory systems 91, a single or plurality of FS memory systems 95, and a single or plurality of FS address units 100.

In one embodiment, a single or plurality of the CFS memory systems 91 stores the flow-control instructions generated and the non-flow-control instructions generated by the control-flow separating compilation 1. A single or plurality of the CFS memory systems 91 further comprises a single or plurality of banks of CFS main memories 92, a single or plurality of banks of lower CFS i-caches 93, and a single or plurality of banks of upper CFS i-caches 94. A single or plurality of the CFS memory system 91 (1) prefetches the instructions stored in the CFS main memories 92 to both of the lower CFS i-caches 93 and the upper CFS i-caches 94 during the lookahead OoO prefetch operations without branch prediction 50 or with branch prediction executed by the CFS prefetcher 111 if the CFS i-cache miss detected from the lower CFS i-caches 93 and (2) fetches the instructions stored in the lower CFS i-caches 93 to the upper CFS i-caches 94 during the lookahead OoO fetch operations with a plurality of BPUs 80 or with a single BPU executed by the CFS fetcher 113 if the CFS i-cache miss detected from the upper CFS i-caches 94.

In one embodiment, a single or plurality of the FS memory systems 95 stores a single or plurality of contiguous instructions associated with a flow-control instruction or a non-flow instruction in CFS generated by the control-flow separating compilation 1. A single or plurality of the FS memory systems 95 further comprises a single or plurality of banks of FS main memories 96, a single or plurality of banks of lower FS i-caches 97, and a single or plurality of banks of upper FS i-caches 98. A single or plurality of the FS memory systems 95 (1) prefetches the contiguous instructions stored in the FS main memories 96 to both of the lower FS i-caches 97 and the upper FS i-caches 98 during the lookahead OoO prefetch operations without branch prediction 50 or with branch prediction executed by the FS prefetcher 112 if the FS i-cache miss detected from the lower FS i-caches 97 and (2) fetches the contiguous instructions stored in the lower FS i-caches 97 to the upper FS i-caches 98 during the lookahead OoO fetch operations with a plurality of BPUs 80 or with a single BPU executed by the FS fetcher 114 if the FS i-cache miss detected from the upper FS i-caches 98.

In one embodiment, a single or plurality of the FS address units 100 further comprises a single or plurality of CFS instruction decoders 101 and a single or plurality of FS address generators 102 integrated with a single or plurality of address counters 103. A single or plurality of the CFS decoders 101 extracts address information from the instructions received from a single or plurality of the CFS memory systems 91. A single or plurality of the FS address generators 102 produces a single or plurality of initial addresses of the contiguous instructions associated with a single or plurality of the decoded instructions in CFS. A single or plurality of the address counters and associated hardware units 103 assists a single or plurality of the FS address generators 102 to continuously generate A single or plurality of the next addresses of a single or plurality of instructions in FS or a single or plurality of blocks of contiguous instructions.

In one embodiment, the lookahead OoO i-fetch frontend processor 110 is integrated with a separated instruction memory system 90 comprising a single or plurality of the CFS memory systems 91 and a single or plurality of the FS memory systems 95 integrated with a single or plurality of FS address units 100. The lookahead OoO i-fetch frontend processor 110 comprises a CFS prefetcher 111, a FS prefetcher 112, a CFS fetcher 113, a FS fetcher 114, and a single or plurality of BPUs integrated with a CFS queue 115 for holding a single or plurality of flow-control instructions, a FS fetch queue 116 for storing a single or plurality of blocks of contiguous instructions, a CFS program counter 117, a FS program counter 118, and a reorder decode buffer 119 for reordering contiguous instructions fetched from the FS memory system 95 and flow-control instructions fetched from the CFS memory system 91 via the BPUs 115 and supplying reordered instructions to a single or plurality of the instruction decoders 121.

The lookahead OoO i-fetch frontend processor 110 fetches each instruction in CFS that represents the contiguous instructions in FS of a basic block or a fragment of a basic block. The lookahead OoO i-fetch frontend processor 110 fetches a plurality of flow-control instructions in CFS within a fewer clock cycles than fetches all instructions of the plurality of the basic blocks. Thereby, the CFS memory system 91 employs small size of storage in CFS i-caches. The flow-control instructions in CFS are fetched a single or plurality of cycles ahead fetching blocks of the contiguous instructions in FS. Cache misses of the plurality of blocks in FS are serviced at least a single or plurality of cycles early. The lookahead OoO i-fetch frontend processor 110 permits utilizing simple and low-power hardware for performing described useful operations. The lookahead OoO i-fetch frontend processor 110 accesses entire contiguous instructions of each basic block or fragment stored in the upper/lower FS i-caches with only an initial address of the basic block or fragment and with the same speed if needed to enhance prefetch and fetch bandwidths.

The lookahead OoO i-fetch frontend processor 110 performs lookahead OoO branch prediction with a single or plurality of BPUs 115 according to the necessitated i-fetch parallelism for determining control flow early and hiding BPU latency. The lookahead OoO i-fetch frontend processor 110 achieves the required i-fetch bandwidth and dynamic basic block expansion with the lookahead OoO fetch operations with a single or plurality of BPUs. The lookahead OoO i-fetch frontend processor 110 performs the lookahead loop operations for low-power and high-performance computing. The lookahead OoO i-fetch frontend processor 110 utilizes low-power and high-resilience CFS i-cache system 93, 94 and FS i-cache system 97, 98 implemented with small, simple, and low-power caches. The lookahead OoO i-fetch frontend processor 110 operates useful functions in processor.

In one embodiment, the CFS prefetcher 111 prefetches a plurality of flow-control instructions and non-flow control instructions in CFS from the CFS memory system 91 without predicting dynamic control flow. The CFS prefetcher 111 prefetches flow-control instructions and non-flow control instructions in CFS from fall-through locations and branch target locations if the branch target locations are obtained. The CFS prefetcher 111 performs the prefetch operations whenever the CFS i-cache miss or the FS i-cache miss is occurred. The CFS prefetcher 111 combining with a BPU prefetches contiguous instructions on the dynamic control flow predicted in order to increase i-prefetch bandwidth, accuracy of prefetch, and resilience of the CFS i-caches 93, 94. The CFS prefetcher 111 combining with or without branch prediction can be chosen according to the demanded resilience of i-cache miss latencies, the desired i-prefetch bandwidth, and/or other useful outcomes.

In one embodiment, the FS prefetcher 112 prefetches a plurality of the blocks of the contiguous instructions in FS associated with the flow-control instructions or the non-flow control instructions in CFS prefetched by the CFS prefetcher 111. The FS prefetcher 112 prefetches the contiguous instructions one or more times whenever the CSF i-cache miss is occurred.

In one embodiment, the CFS fetcher 113 fetches a plurality of flow-control instructions and non-flow control instructions in CFS from the CFS memory system 91 with predicting dynamic control flow by a single or plurality of BPU with the CFS queue 115. The CFS fetcher 113 fetches flow-control instructions and non-flow control instructions in CFS from the locations predicted to take branches or not to take branches. The CFS fetcher 113 updates the CFS program counter 117. The fetched flow-control instructions that need to be predicted are stored to the CFS queue integrated with the BPUs 115 for performing lookahead OoO fetch operations. The CFS fetcher 113 performs the fetch operations whenever the CFS program counter 117 is updated with new value that is obtained (1) from the CFS fetcher 113 that changes the CFS program counter values due to fetch instructions in CFS or fetch the jump or call instructions in CFS, (2) from the single or plurality of BPU with the CFS queue 115 after prediction, (3) from the backend processor 120 due to disrupted operations, comprising branch miss predictions, interrupts, and exceptions, and (4) from the operations that force to change the CFS program counter values. The CFS fetcher 113 combining with the BPUs 115 fetches instructions in CFS according to the dynamic control flow predicted in order to increase i-prefetch bandwidth, accuracy of prefetch, and resilience of the CFS i-caches 93, 94. The CFS fetcher 113 combining with BPUs 115 increases resilience of i-cache miss latencies, the i-fetch bandwidth, and/or other useful outcomes related i-fetch operations.

In one embodiment, the FS fetcher 114 fetches a plurality of the blocks of the contiguous instructions in FS associated with the flow-control instructions or non-flow control instructions in CFS fetched by the CFS fetcher 114. The FS fetcher 114 fetches the contiguous instructions whenever an instruction in CFS is fetched by the CFS fetcher 113. The FS fetcher 114 terminates to fetch the contiguous instructions in FS whenever fetching the last instruction of the contiguous instructions or receiving a delimiter indicating that the last instruction is fetched. The fetched contiguous instructions are stored to the FS fetch queue 116. The FS fetcher 114 fetches a single or plurality of blocks of contiguous instructions in FS to a FS fetch queue 116 while the CFS fetcher 113 fetches flow-control instructions in CFS predicted by a single or plurality of the BPUs 115.

In one embodiment, the reorder decode buffer 119 reorders the contiguous instructions fetched from the FS fetch queue 116 and the flow-control instructions fetched from the CFS queue integrated with the BPUs 115. The reorder decode buffer 119 temporally stores the reordered instructions and forwards the reordered instructions to a single or plurality of instruction decoders 121 and other units typically found in an in-order or OoO backend processor 122 in prior arts. The reorder decode buffer 119 performs as a loop buffer to hold the reordered instructions in a single or plurality of loops and to forward the instructions of the loops to a single or plurality of instruction decoders according to the an access pointer while shutting down the separated instruction memory system 90 and the pairs of the CFS/FS prefetchers 111, 112 and the CFS/FS fetchers 113, 114.

In one embodiment, the backend processor 120 comprises a single or plurality of instruction decoders 121 and an in-order or an out-of-order backend 122. A single or plurality of the instruction decoders 121 receives reordered instructions from the reorder decode buffer 119 and decodes the instructions and forwards to the in-order or an out-of-order backend 122. The backend processor 120 handles disrupted operations comprising branch miss predictions, interrupts, and exceptions with the CFS program counter 117, the FS program counter 118, and other components shown in the lookahead OoO i-fetch frontend processor 110. Thereby, the backend processor 120 integrated to the invented lookahead OoO i-fetch frontend processor 110 and the invented separated i-memory system 90 maintains compatibility of the program in prior arts and enhances performance and operational energy efficiency.

What is claimed is:

1. A lookahead processor system comprising:
a control-flow separating compilation system;
a separated instruction memory system;
a lookahead out-of-order (OoO) instruction fetch (i-fetch) frontend processor; and
a backend processor,
wherein the control-flow separating compilation system compiles a plurality of flow-control instructions (FCIs) related to a plurality of control flows of a program into a control-flow subprogram (CFS) and remaining instructions of the program into a functional subprogram (FS),
wherein the separated instruction memory system stores the CFS to a CFS memory system and the FS to a FS memory system,
wherein the lookahead OoO i-fetch frontend processor delivers a single or plurality of instructions in the CFS memory system to the backend processor first and then deliver a single or plurality of instructions from the FS memory system to the backend processor,
wherein the backend processor decodes and executes a single or plurality of the instructions of the CFS memory system and a single or plurality of the instructions of the FS memory system via the lookahead OoO i-fetch frontend processor,
wherein the lookahead processor system is operable to:
separate control flow from the program comprising a plurality of basic blocks;
generate the CFS and the FS;
prefetch and fetch a single or plurality of the instructions in the CFS and the FS from the instruction memory system to the lookahead OoO i-fetch frontend processor;
fetch a single or plurality of FCIs in the CFS to a single or plurality of branch prediction units before or at least the same cycle starting to fetch a single or plurality of blocks of contiguous instructions (CIs) associated with a single or plurality of the fetched FCIs in sequence or in parallel;
predict a single or plurality of the fetched FCIs in the CFS in a single or plurality of branch prediction units (BPUs) in the lookahead OoO i-fetch frontend processor;
reorder a single or plurality of the fetched FCIs in the CFS and a single or plurality of blocks of the CIs in the FS regardless of the order of the FCIs fetched from the CFS and the CIs fetched from the FS; and
forward the reordered FCIs and CIs to an in-order or an out-of-order backend processor.

2. The lookahead processor system of claim 1, wherein the control-flow separating compilation system further comprising:
an identifier that distinguishes a plurality of types and sizes of basic blocks in a program compiled for a target processor and identifies FCIs found from the basic blocks or the fragmented basic blocks;
a FS compiler that produces a FS containing a plurality of CIs of basic blocks and fragments of the basic blocks found in the program, wherein the CIs in the FS do not contain any FCIs of the basic blocks; and
a CFS compiler that produces a CFS containing FCIs and temporary non-flow-control instructions (non-FCIs) that represent basic blocks and fragments of basic blocks found in the program,
wherein the identifier is operable to:
identify a FCI at a branch address in a program, wherein the branch address is an address of the FCI, wherein the FCI changes control-flow of the program;
identify an instruction at a branch target address in the program, wherein the branch target address is a target address of a taken FCI;
identify an instruction at a next FCI address and before the branch target address in the program;
identify a single or plurality of CIs between the identified instruction at the branch target address and the identified FCI at the branch address in the program if the CI or a first CI of plurality of the CIs at the branch target address is identified,
otherwise, identify a single or plurality of CIs between the identified instruction at the next FCI address and the identified FCI at the next branch address in the program;
continuously identify a single or plurality of next CIs from the program until last CIs in the program are found;
wherein the FS compiler is operable to:
append a single or plurality of the identified CIs to the identified instruction at the branch target address if the identified instruction is at the branch target address,
if the identified instruction at the next FCI address is not the identified instruction at the branch target address, a single or plurality of the CIs is not appended to any instruction;
modify a single or plurality of the CIs to identify a last CI of the CIs if a plurality of the CIs are identified, wherein the last CI is to terminate accesses of the CIs from the FS memory system in the instruction memory system,
if the single CI is identified, then the FS compiler identifies the single CI as the last CI;
remove a single or plurality of the appended CIs from the program if the CIs are appended to an instruction at the branch target address,
if the CIs are not appended to any instruction, removes the CIs from the program and inserts a temporary non-FCI to the address of a first CI of the removed CIs from the program;
allocate a single or plurality of the appended CIs to an instruction at the branch target address or the non-appended CIs to a single or plurality of addresses in an FS,
if parallel accesses of the appended CIs or the non-appended CIs from an instruction thread are required, then the FS compiler allocates a single or plurality of the appended CIs or the non-appended CIs to a single or plurality of addresses that are accessible concurrently from the FS memory system in the instruction memory system, wherein the instruction thread is a sequence of instructions that can be executed independently,
if a block of a CI cache contains fewer than the appended CIs or the non-appended CIs, then the FS compiler allocates a single or plurality of CI fragments to a single or plurality of addresses that are accessible, wherein the CI fragment is a sequence of CIs that are fewer than equal to the CIs stored to the block of the CI cache;
add an initial address of a single or plurality of the allocated CIs in the FS to a lookup table if the allocated CIs are not fragmented, wherein the lookup table is an array for retrieving an address of the initial CI with an indexing operation by the CFS compiler,
if the allocated CIs are fragmented, then the FS compiler adds an initial address of the allocated CI fragment in the FS to the lookup table;
continuously append, and remove a single or plurality of next CIs from the program until last CIs in the program are found;
continuously allocate next CIs in the FS until last CIs in the program are found; and
continuously add an initial address of the allocated CIs in the FS to the lookup table,
wherein the CFS compiler is operable to:
reassign addresses of FCIs and temporary non-FCIs in the program according to a sequence of the FCIs and a sequence of the temporary non-FCIs in the program after the FS compilation;
identify instructions at branch addresses in the program as the FCIs;
identify the temporary non-FCIs inserted by the FS compiler;
modify the FCIs and the temporary non-FCIs to access initial addresses of associated CIs and CI fragments by utilizing addresses stored in the lookup table;
modify each of the FCIs to access the associated CIs for branching to an FCI or a temporary non-FCI at a branch target address of each of the FCIs;
allocate the modified FCIs and the modified temporary non-FCIs at the branch addresses to the CFS,
if parallel accesses of the FCIs and the temporary non-FCIs from an instruction thread are required,
then the CFS compiler allocates a single or plurality of the FCIs and the temporary non-FCIs to a single or plurality of addresses that are accessible from the CFS memory system in the instruction memory system,
if a block of an FCI cache contains fewer than the FCIs and the temporary non-FCIs, then the CFS compiler allocates a single or plurality of the FCIs and the temporary non-FCIs to a single or plurality of addresses that are accessible;
continuously identify and modify a single or plurality of next FCI or temporary non-FCI from the program until last FCI or last temporary non-FCI in the program is found; and
continuously allocate the next FCI or the next temporary non-FCI in the CFS until the last FCI or the last temporary non-FCI in the program is found.

3. The lookahead processor system of claim 1, wherein the separated instruction memory system further comprises:
a single or plurality of CFS memory systems;
a single or plurality of FS memory systems; and
a single or plurality of FS address units, wherein the separated instruction memory system is operable to:
store FCIs in the CFS to a single or plurality of the CFS memory systems in sequence or in parallel;
access the FCIs in the CFS to a single or plurality of the CFS memory systems in sequence or in parallel;
store CIs in the FS to a single or plurality of the FS memory systems in sequence or in parallel;
access CIs in the FS to a single or plurality of the FS memory systems in sequence or in parallel; and
generate a single or plurality of FS addresses to access CIs from a single or plurality of the FS memory systems in sequence or in parallel.

4. The separated instruction memory system of claim 3, wherein a single or plurality of the CFS memory systems further comprises:
a single or plurality of banks of CFS main memories;
a single or plurality of banks of lower-level CFS i-caches; and
a single or plurality of banks of upper-level CFS i-caches, wherein a single or plurality of the CFS memory systems is operable to:
store FCIs generated by the control-flow separating compilation system to the CFS main memories;
prefetch the FCIs stored in the CFS main memories to the lower-level CFS i-caches and the upper-level CFS i-caches if a CFS i-cache miss is detected from the lower-level CFS i-caches and another CFS i-cache miss is detected from the upper-level CFS i-caches, wherein the CFS i-cache misses are detected when the FCIs are not found from the lower-level CFS i-caches and from the upper-level CFS i-caches;
prefetch the FCIs stored in the lower-level CFS i-caches to the upper-level CFS i-caches if a CFS i-cache miss is detected from the upper-level CFS i-caches but a CFS i-cache hit is detected from the lower-level CFS i-caches, wherein the CFS i-cache hit is detected when the FCIs are found from the lower-level CFS i-caches; and
perform a single or plurality of lookahead OoO fetches of the FCIs from the upper-level CFS i-caches to a plurality of the BPUs in a lookahead OoO i-fetch frontend processor if a CFS i-cache hit is detected from the upper-level CFS i-caches, wherein a single or plurality of the lookahead OoO fetches of the FCIs to the BPUs is that the FCIs are fetched to the BPUs within a single or plurality of cycles before fetching a single or plurality of first CIs associated with a single or plurality of the FCIs to the lookahead OoO i-fetch frontend processor,
otherwise, access a plurality of the FCIs stored in the lower-level CFS i-caches to the upper-level CFS i-caches.

5. The separated instruction memory system of claim 3, wherein a single or plurality of the FS memory systems further comprises:
a single or plurality of banks of FS main memories;
a single or plurality of banks of lower-level FS i-caches; and
a single or plurality of banks of upper-level FS i-caches, wherein a single or plurality of the FS memory systems is operable to:
store a single or plurality of CIs associated with a FCI or a non-FCI in the CFS generated by the control-flow separating compilation;
prefetch the CIs stored in the FS main memories to the lower-level FS i-caches and the upper-level FS i-caches if an FS i-cache miss is detected from the lower-level FS i-caches and another FS i-cache miss is detected from the upper-level FS i-caches, wherein the FS i-cache misses are detected when the CIs are not found from the lower-level FS i-caches and from the upper-level FS i-caches;
prefetch the CIs stored in the lower-level FS i-caches to the upper-level FS i-caches if a FS i-cache miss is detected from the upper-level FS i-caches but a FS i-cache hit is detected from the lower-level FS i-caches, wherein the FS i-cache hit is detected when the CIs are found from the lower-level FS i-caches; and
fetch the CIs from the upper-level FS i-caches to a plurality of FS fetch queues in the lookahead OoO i-fetch frontend processor if a FS i-cache hit is detected from the upper-level FS i-caches, wherein a single or plurality of the CI fetches to the FS fetch queues is that the CIs are fetched to the FS fetch queues within a single or plurality of cycles after fetching a single or plurality of FCIs associated with a single or plurality of the CIs to the lookahead OoO i-fetch frontend processor,
otherwise, access a plurality of the CIs stored in the lower-level FS i-caches to the upper-level FS i-caches.

6. The separated instruction memory system of claim 3, wherein a single or plurality of the FS address units further comprises:
a single or plurality of CFS instruction decoders;
a single or plurality of FS address generators; and
a single or plurality of address counters, wherein a single or plurality of the FS address units is operable to:
produce a single or plurality of initial addresses of blocks of CIs associated with a single or plurality of FCIs from decoded data of the FCIs received from a single or plurality of the CFS instruction decoders in sequence or in parallel;
transmit a single or plurality of the initial addresses of the blocks of the CIs to a single or plurality of the FS memory systems and the address counters;
receive a single or plurality of counter values that are continuously updated from the initial addresses of the blocks of the CIs in a single or plurality of the FS memory systems in every access cycle of the FS memory systems until a single or plurality of last blocks of the CIs is accessed;
transmit a single or plurality of the received addresses of the blocks of the CIs to a single or plurality of the FS memory systems and the address counters; and
transmit a single or plurality of control signals to initialize a single or plurality of the address counters to terminate a single or plurality of accesses of the FS memory systems,
wherein a single or plurality of the CFS decoders is operable to extract address information from the FCIs received from the CFS memory systems,
wherein a single or plurality of the FS address generators is operable to produce an initial address of the CIs associated with the decoded FCIs in the CFS, and
wherein a single or plurality of the address counters and associated hardware units are operable to assist a single or plurality of the FS address generators to generate next address of a CI in the FS or a block of CIs.

7. The lookahead processor system of claim 1, wherein the lookahead OoO i-fetch frontend processor further comprises:
a pair of a CFS prefetcher and an FS prefetcher;
a pair of a CFS fetcher and an FS fetcher;
a single or plurality of BPUs integrated with a CFS queue;
a CFS program counter;
an FS fetch queue integrated with an FS program counter; and
a reorder decode buffer, wherein the lookahead OoO i-fetch frontend processor is operable to:
prefetch a single or plurality of FCIs and non-FCIs from the CFS memory systems in sequence or in parallel from a fall-through location and a branch target location according to availability of the branch target location whenever a CFS i-cache miss or an FS i-cache miss is occurred;
prefetch a single or plurality of the FCIs and the non-FCIs before or at least the same cycle prefetching a single or plurality of blocks of CIs from the FS memory systems in sequence or in parallel;
fetch a single or plurality of the FCIs and the non-FCIs from the CFS memory systems to the CFS queue in sequence or in parallel before or at least the same cycle fetching a single or plurality of the blocks of the CIs from the FS memory systems to the FS queue in sequence or in parallel;
predict a single or plurality of branch operations of the FCIs fetched to the CFS queue integrated with a single or plurality of the BPUs;
determine control flow early to avoid fetching other FCIs from wrong path by updating a single or plurality of CFS program counter values;
reorder a single or plurality of the blocks of the CIs fetched from the FS fetch queue and the FCIs fetched from the CFS queue integrated with the BPUs; and
store temporally and forward the reordered CIs and FCIs to a single or plurality of instruction decoders, and other units found in an in-order or OoO backend processor,
wherein the CFS prefetcher is operable to:
prefetch a plurality of FCIs and non-FCIs from the CFS memory system;
prefetch a single or plurality of the FCIs and the non-FCIs from fall-through locations and branch target locations if the branch target locations are obtainable;
prefetch a single or plurality of FCIs and non-FCIs whenever a CFS i-cache miss is occurred; and
prefetch a single or plurality of FCIs on a single or plurality of dynamic control flows predicted with a single or plurality of the BPUs in order to increase i-prefetch bandwidth, accuracy of prefetch, and resilience of the lower- and the lower-level CFS i-caches,
wherein the FS prefetcher is operable to:
prefetch a single or plurality of blocks of CIs associated with a single or plurality of the FCIs or the non-FCIs prefetched by the CFS prefetcher; and
prefetch a single or plurality of the blocks of the CIs one or more times whenever an FS i-cache miss is occurred,
wherein the CFS fetcher is operable to:
fetch a single or plurality of FCIs and non-FCIs from the CFS memory system with predicting dynamic control flow by a single or plurality of BPUs with the CFS queue;
fetch a single or plurality of FCIs and non-FCIs from a single or plurality of predicted locations of taken branches or not-taken branches;
update a single or plurality of values in the CFS program counter in order to store a single or plurality of the FCIs that need to be predicted to the CFS queue, wherein a single or plurality of the values is a single or plurality of locations of the FCIs;
initiate to fetch a single or plurality of FCIs and non-FCIs whenever the CFS program counter is updated with a single or plurality of new values, wherein a single or plurality of the new value is obtained from:
the CFS fetcher that changes a single or plurality of values of the CFS program counter due to fetch a single or plurality of FCIs or non-FCIs comprising a single or plurality of jump or call instructions;
a single or plurality of the BPUs with the CFS queue after prediction; and
the backend processor due to disrupted operations, comprising branch miss predictions, interrupts, and exceptions; and
fetch a single or plurality of FCIs on a single or plurality of dynamic control flows predicted with a single or plurality of the BPUs in order to increase i-prefetch bandwidth, accuracy of prefetch, and resilience of the lower- and the lower-level CFS i-caches,
wherein the FS fetcher is operable to:
fetch a single or plurality of blocks of CIs associated with a single or plurality of the FCIs or the non-FCIs fetched by the CFS fetcher;
fetch a single or plurality of the blocks of the CIs whenever a single or plurality of the FCIs or the non-FCIs is fetched by the CFS fetcher;
terminate to fetch a single or plurality of the blocks of the CIs whenever fetching a single or plurality of last blocks of CIs or receiving a delimiter indicating that a last CI is fetched, wherein the last block of the CIs associated with a FCI or a non-FCI comprises a CI located at the last in the block in programmed order, and wherein the delimiter is to indicate a last CI of a FCI or a non-FCI; and
fetch a single or plurality of blocks of CIs to the FS fetch queue while the CFS fetcher fetches a single or plurality of FCIs predicted by a single or plurality of the BPUs,
wherein a single or plurality of the BPUs integrated with the CFS queue is operable to:
predict a single or plurality of taken or non-taken branches of FCIs received from the CFS queue;
forward a single or plurality of values of branch target locations to the CFS program counter;
forward a single or plurality of the FCIs predicted to the reorder decode buffer; and
hold a single or plurality of the FCIs fetched in the CFS queue,
wherein the CFS program counter is operable to hold a single or plurality of values to fetch a single of plurality of FCIs and non-FCIs;
wherein the FS fetch queue integrated with a FS program counter is operable to:
store a single or plurality of blocks of CIs fetched to a single or plurality of entries of the FS fetch queue; and
forward a single or plurality of the blocks of the CIs stored in the FS fetch queue to the reorder decode buffer; and
hold a single or plurality of the FCIs fetched in the CFS queue,
wherein the reorder decode buffer is operable to:
reorder a single or plurality of blocks of CIs received from the FS fetch queue and a single or plurality of FCIs received from the CFS queue by appending an FCI to a last CI associated to the FCI;
hold a single or plurality of the reordered blocks of the CIs and a single or plurality of the reordered FCIs;
forward the reordered blocks of the CIs and the reordered FCIs to a single or plurality of instruction decoders and other units in an in-order or OoO backend processor; and
perform as a loop buffer to hold the reordered blocks of the CIs and the reordered FCIs in a single or plurality of loops and forward the reordered blocks of the CIs and the reordered FCIs of the loops to a single or plurality of the instruction decoders without accessing the CIs and the FCIs of the loops from the separated instruction memory system and the pair of the CFS prefetcher and the FS prefetcher and the pair of the CFS fetcher and the FS fetcher.

8. The lookahead processor system of claim 1, wherein the backend processor further comprises:
a single or plurality of instruction decoders; and
an in-order or out-of-order backend;
wherein a single or plurality of the instruction decoders is further operable to:
access a single or plurality of reordered blocks of CIs and reordered FCIs in the reorder buffer in sequence or in parallel;
decode the accessed instructions in sequence or in parallel; and
forward decoded outputs of a single or plurality of the reordered blocks of the CIs and the reordered FCIs to the in-order or out-of-order backend,
wherein the in-order or out-of-order backend is further operable to:
access an interrupt unit, an exception unit, and a branch misprediction service unit;
access a single or plurality of in-order or out-of-order issue units, execution units, and other components in the backend processor,
wherein the backend processor is further operable to:
receive the decoded outputs from a single or plurality of the instruction decoders;
execute the decoded outputs to produce the compatible results of the program; and
detect and process disrupted operation requests from the interrupt unit, the exception unit, and the branch misprediction service unit.
